(19) United States
(12) Patent Application Publication
(10) Pub. No.: US 2016/0085732 A1
(43) Pub. Date: Mar. 24, 2016

(54) CHECKING LINKS

(71) Applicant: International Business Machines Corporation, Armonk, NY (US)

(72) Inventors: Olivier Boehler, JACOU (FR); Ivan Deleuze, Montpellier (FR); Guilhaume Garcia, Montpellier (FR); Bastien Pino, Junas (FR)

(21) Appl. No.: 14/845,621

(22) Filed: Sep. 4, 2015

(30) Foreign Application Priority Data
Sep. 24, 2014 (GB) 1416810.8

(51) Int. Cl. G06F 17/22

(52) U.S. Cl. CPC G06F 17/2235

(57) ABSTRACT

A method of checking links in a message comprises detecting the creation of a new message, detecting the presence of one or more links in the message, determining if each link is invalid, and highlighting each link that is determined to be invalid. The highlighting of each link that is determined to be invalid occurs as the message is created or when a send message request is received.

### FIELD OF THE INVENTION

This invention relates to a method of, and system for checking links in a message.

### BACKGROUND

Today more and more electronic files are being shared via cloud services. The desktop computing environments of end users are often virtualized in a cloud computing model and instead of directly exchanging files using email, the access to the data is more often achieved via URLs that are links to these files in the cloud. The problem is to guarantee the quality of these URLs when they are typed into messages. A classic problem faced by users who use this kind of messages is the sharing of an invalid URL. There are three main problems in the process of checking a link. Firstly, this checking must be done manually which can be unnecessarily time consuming if the content that is being shared contains several links. Secondly, the status of a link can change, since a link that was identified as working previously can be dead after a certain period of time. Forwarding an email that is supposed to contain links that did work can in fact contain dead links. Thirdly, the receiver of the information does not necessarily have the same level of access to a website, or the receiver could be on a different network. A link that works for a sender will not necessarily work for the receiver, for example the sender may be behind a firewall and the URL that they want to transmit requires the access to the firewall.

### BRIEF SUMMARY OF THE INVENTION

According to a first aspect of the present invention, there is provided a method of checking links in a message, the method comprising the steps of detecting the creation of a new message, detecting the presence of one or more links in the message, determining if each link is invalid, and highlighting each link that is determined to be invalid.

According to a second aspect of the present invention, there is provided a system for checking links in a message, the system comprising a processor arranged to detect the creation of a new message, detect the presence of one or more links in the message, determine if each link is invalid, and highlight each link that is determined to be invalid.

According to a third aspect of the present invention, there is provided a computer program product on a computer readable medium for checking links in a message, the product comprising instructions for detecting the creation of a new message, detecting the presence of one or more links in the message, determining if each link is invalid, and highlighting each link that is determined to be invalid.

Owing to the invention, it is possible to provide an automatic validation of links as soon as they are typed or pasted into a message. The method and system will operate to validate links that are used in messages such as email and instant messenger. This can be used to prevent the sender from sending a message that contains an incorrect URL. The core idea is to ask software or a service to perform the URL validation as a message is being created. The implementation of this solution would drastically reduce the number of messages that have to be sent twice because there was an error into the original message. By reducing to zero the instance of invalid links in a message, the sender will avoid a loss of confidence from their interlocutor, the sender will be 100% sure that the content of their message is available at the receiver and services such as email newsletters will not contain incomplete information anymore and newsletter campaigns will be more efficient.

The solution is automatically to check the content of a message when the “send” button is pressed or when the text is typed. In a preferred embodiment, as soon as an “invalid link checker” detects an invalid link, the checker will highlight it and (optionally) prevent the message from being sent. The user can then correct the error. The “invalid link checker” will validate if each link is good or not.

From the email (or message) receiver point of view it is painful to analyse the root cause of an invalid link and time consuming to ask again for the accurate information. The cost at the IT level is double, because wrong information has been sent, and a request for accurate information has to be sent back to sender. This represents overhead and time loss for an enterprise, which can represent millions of lost hours a year.

In a preferred embodiment, the system will analyse links during the message creation as a background checking task, send the links to a cloud service and ask for a validation of this links and highlight the links as a function of the state of the link. The highlighting of links that are determined to be invalid occurs as the message is created or when a send message request is received. If a link is considered invalid (for example if an error message is returned from the link or redirection from the original link occurs) then the link can be highlighted in the message that the user is creating. This highlighting can occur immediately a link is entered into the message or only when the user actually tries to send the message. The system can also prevent the sending of the message if the message contains one or more invalid links.

The user is therefore provided with immediate feedback before a message is sent, as to whether the link(s) in the message are actually valid. If they are not valid then the user will be immediately aware of this and can correct the invalid link(s) to ensure that time is not wasted by the recipient of the message in trying to access the invalid link(s). An invalid link is one that will not work for the recipient, either because the link is dead or because some kind of access requirement is needed for the link which the recipient does not have. A dead link is a link which (in the context of the Internet) does not comprise a live URL. Such a dead link can occur if the link is mistyped for any reason or if the content that was placed at the end of the link is no longer there.

If the user is blocked from the sending their message with any invalid link(s) then the system ensures that no message is sent out with invalid link(s) and the user must find and correct each of the links that are invalid. For example, if a user attempts to forward an email that contains one or more links that no longer work, then the user will be unable to send the email until they have either removed the link(s) or substituted a link that does work. Similarly in an instant message environment, if a user tries to post a message on a social network with a link to a photo that no longer exists, then the system will prevent the user from performing the “post” action for the specific message.

Any invalid link in a message will be highlighted to the user, either when the link is created in the message, or when the user attempts to send the message. This highlighting could be achieved with the use of colour coding, for example. A valid link could be highlighted as green, with a dead link highlighted as red and a “redirect” link highlighted as yellow, for example. This colour coding will help the user to identify the invalid link(s) in the message in a quick and simple manner and as the user corrects an invalid link then they will be able to see by the change in colour of the link that the link is now valid. For example, if a user misspells a link (as commonly occurs) then the link will be highlighted red as an invalid link. This will draw the user to the invalid link and once they have corrected the spelling in the link, then the link highlighting colour will change to green, to indicate to the user that the link is now valid.

### BRIEF DESCRIPTION OF THE DRAWINGS

Preferred embodiments of the present invention will now be described, by way of example only, with reference to the following drawings, in which:

FIG. 1 is a schematic diagram of a desktop computing system;

FIG. 2 is a flowchart of a method if checking links in a message;

FIG. 3 is a schematic diagram of a mobile phone;

FIG. 4 is a schematic diagram of the mobile phone connecting to a server; and

FIG. 5 is a further flowchart of a method if checking links in a message.

### DETAILED DESCRIPTION OF THE DRAWINGS

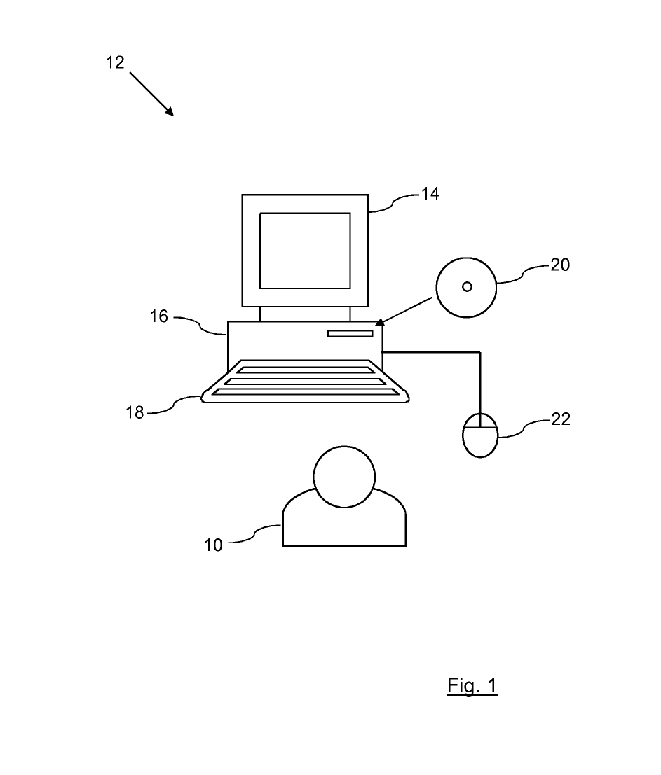

FIG. 1 shows a user 10 using a desktop computer system 12 to create a message. The computer system 12 comprises a display device 14, a processor 16 and a user input device (a conventional keyboard) 18. The processor 16 is connected to the display device 14 and the user input device 18. The processor 16 is running a suitable software application such as an email application with which the user 10 can interact via a graphical user interface of the application, which is being displayed by the display device 14. A CD-ROM 20 is shown, which can be used to store a copy of the application which is being executed by the processor 16.

An additional user interface device 22 is also shown, which is a conventional mouse 22. The user 10 utilises the keyboard 18 and mouse 22 to interact with the email application that is being run by the processor 16, which is displaying the message that the user 10 is creating and viewing on the display device 14. As the user types their message on the keyboard 18, then the corresponding text will be viewable in the graphical user interface of the email application, which is shown by the display device 14. The CD-ROM 20 contains a computer program product that comprises instructions for controlling the processor 16 in running the email application.

As the user types their message into the email application via the keyboard 18, then they may enter one or more links in the message that they intend to send to one or more recipients. The Internet allows users to link to content (such as web pages and so on) by providing a URL, which will be used by a web browser to navigate to the content. However, a link has to be typed correctly otherwise it will not function properly, even though the email application will recognise the presence of a link. The email application has the functionality to check the validity of any links provided by the user and to warn them accordingly.

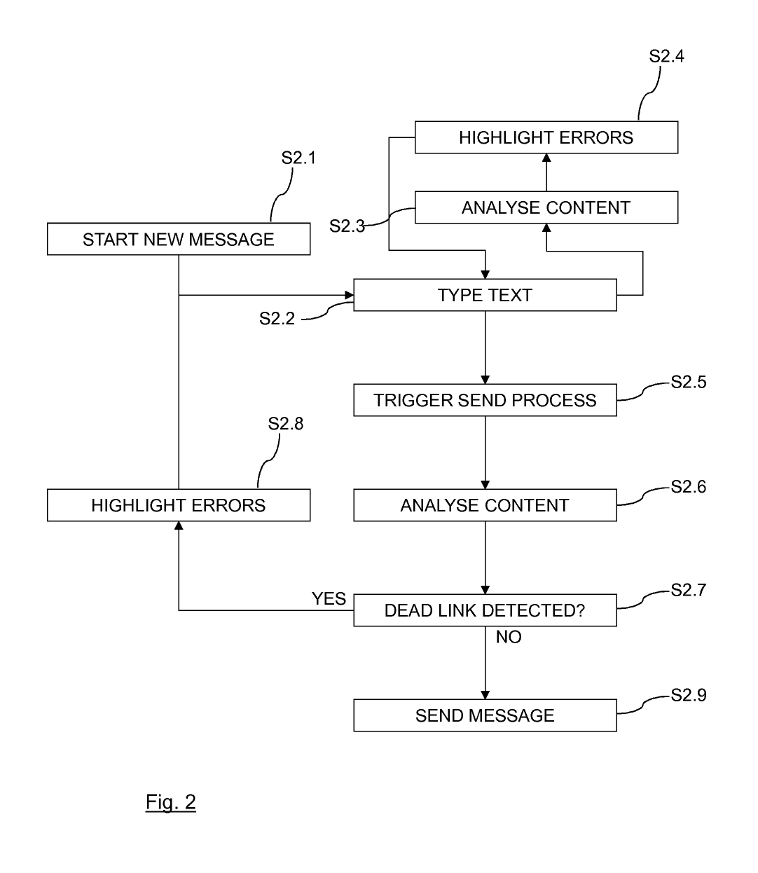

This process is illustrated in FIG. 2. At step S2.1, the user starts a new message and at step S2.2, the user types text into their new message. At step S2.3, a parsing process will read continuously the content of an email that is currently being written by the user. As soon as the checker finds a link, the checker validates the link and tries to open the link, which is transparent for the user so that can continue to write their message. In order to know if a link is dead or not, the checker will check the HTTP return code and/or wait for a timeout. For example, error 403 is “page is forbidden”, which means that the destination server does not allow the user to reach the URL, even if this page exists. Error 404 is “page not found”, which means that the webserver exists (ex: www.ibm.com) but the specific page does not (ex: www.ibm.com/mywebpage.html).

Then the checker will split links into three categories, good, dead and warning. If the link is good, the user does not notice anything and can continue to write their message. The user can send the message if they wish. If the link is dead, then the link is highlighted at step S2.4 and the user has to change it. If the link is designated as “Warning”, then the link requires an authorized access. This information is shared with the user who can decide if they do wish to send this kind of link in their message. When the user presses the “send” button, at step S2.5, a last pass is done. If a dead link is still present in the message (as checked in steps S2.6 and S2.7), then this is highlighted in step S2.8 and the user is invited to fix the invalid link or to bypass this warning. Once the message is correct, it can be sent at step S2.9.

Visually, the status of each type of link could take a different colour for example, in order to highlight the status of the link to the user in the graphical user interface of the email application. This colour coding will help the sender to identify the information that is incorrect. For example, the link www.ibm.com was analysed as a correct link and can be shown in green. The link www.iibbm.com (with two “i”s and two “b”s is dead, as this website does not exist) can be shown in red. A link that seems to require a firewall logon because the link automatically redirected the browser to a firewall page has a warning displayed, which could use a yellow colour, for example.

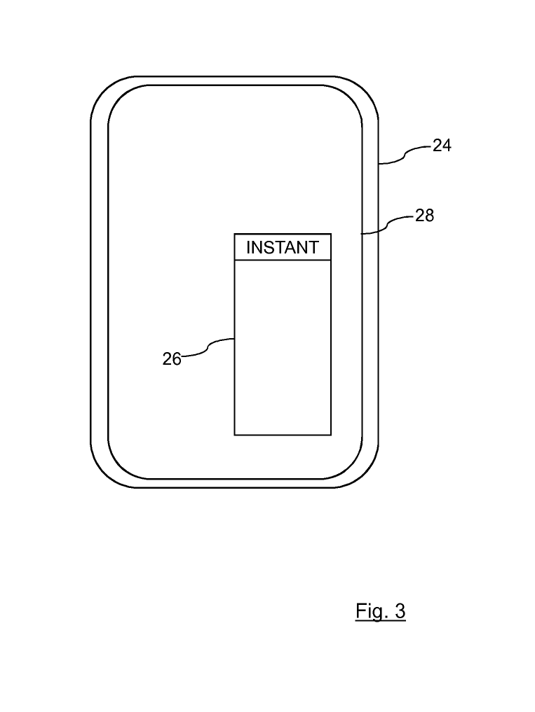

FIG. 3 shows a mobile phone 24, which is displaying a graphical user interface 26 to an instant messaging application on a touchscreen 28. A user can communicate directly with another user by composing messages in the instant messaging application. The mobile phone 24 is a modern smartphone which has significant processing, memory and network capabilities and can communicate via short range (WiFi) networks and via a wide area network (3G). The majority of the front of the mobile phone 24 is taken up with a touchscreen 28, which the user can touch to access the graphical user interface 26 of the instant messaging application, composing and sending messages to one or more recipients.

When a user wishes to compose a message, the lower half of the graphical user interface 26 will adapt to show a standard QWERTY keyboard, which the user can access by pressing virtual buttons that correspond to keys of the keyboard to generate the text of their message. A “return” key is also present in the virtual keyboard, which the user will press once they have completed their current message, and the pressing of this key sends the completed message to the recipient(s). The completed and sent message will then join a thread of messages that can be scrolled up and down in order to see the different messages within the graphical user interface 26.

If the user should include any links within their message, then as they are typing, these links are checked to see if they are valid or not. In an instant messaging environment, a link may be to a photograph posted onto a social networking website, for example. The link will comprise the URL of the specific photo. The background service will check whether the link entered by the user is actually valid, as the user may have mistyped the link address or the photograph may no longer be present at the link, as it may have been subsequently removed. If the link is no longer valid, for any reason, then this will be highlighted to the user as they compose the message.

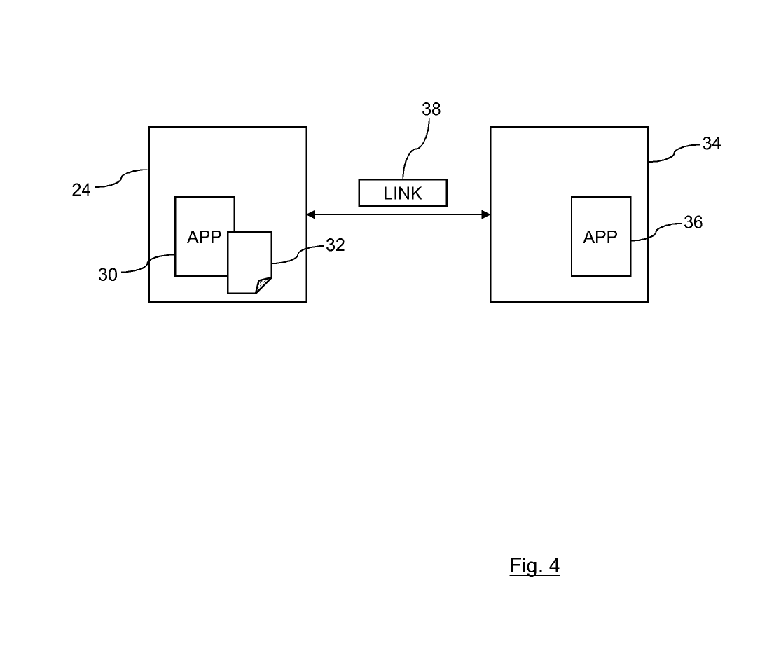

FIG. 4 illustrates schematically how the link validation can occur using a remote service. The user's device 24 is running a messaging application 30, with which the user interacts via a graphical user interface to the messaging application 30. As the user creates a message 32, then the device 24 is in communication with a remote server 34. This server 34 is running a checking application 36, which is configured to check links such as URLs. Once the user types a link into their message 32, then the link 38 is communicated to the server 34 by the user's device 24. The checking application 36 receives the link 38.

Once a link 38 has been received by the checking application 36 on the server 34, then the checking application 36 performs a defined protocol to determine if the submitted link 38 is valid or not. The checking application 36 will firstly attempt to access the link 38 using a suitable request to the link 38. If the link 38 is accessed with no problems, then the link 38 is considered valid and this is communicated back to the messaging application 30 on the user's device 24. If the link 38 cannot be accessed, then the link 38 is considered to be invalid and this is also returned to the messaging application 30 on the user's device 24.

The checking application 36 can also determine more information if the link 38 cannot be accessed, specifically distinguishing between the cases where no content can be accessed at all (the link 38 is dead) and those cases where some kind of redirection is enforced when the link 38 is attempted to be accessed. Redirection will occur, for example when a request is made for the person accessing the link 38 to authenticate themselves, for example with a log-in id and a password. In this case, the link 38 will still be considered to be invalid, even though the content is present at the link 38. The checking application 36 can indicate back to the messaging application 30 that the link 38 is invalid for this reason (redirection).

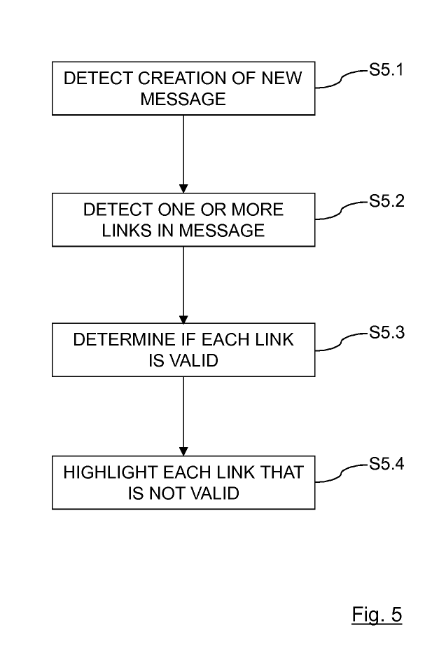

FIG. 5 summarises the method of checking links in a message. The method comprises the steps of, firstly step S5.1 detecting the creation of a new message, secondly step S5.2 detecting the presence of one or more links in the message, thirdly step S5.3 determining if each link is invalid, and finally step S5.4 highlighting each link that is determined to be invalid. All of these steps can be carried out by the device that the user is using to create their message, or if a distributed model is being used (as shown in FIG. 4, for example) then the third step, which comprises determining if the link is invalid, can be carried out remotely by a dedicated service.

The final step of the method, which comprises highlighting each link that is determined to be invalid, may occur as the user is typing their message or may only occur at the moment that the user tries to send their message. This can be configured by the user, depending upon their personal preference. If the user prefers the highlighting to take place immediately, then as soon as a link is determined to be invalid, this link will be highlighted in the graphical user interface, for example in red, indicating to the user that the proposed link in their message does not work. Otherwise, links are only highlighted once the user presses the send or post button.

The method can be configured so that the user is actually prevented from their message if any of the links within the message are actually invalid. This can be enforced at an enterprise level, for example within a large business, in order to reduce the amount of message traffic that will occur as a result of the sending of an invalid link to another user. Once the user tries to send their message, any invalid links will have to be corrected or deleted before the message can be sent. The highlighting supports the user easily locating those links within their message that need to be dealt with since they are determined to be invalid.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of checking links in a message, the method comprising the steps of:
detecting a creation of a new message;
detecting a presence of one or more links in the message;
determining if each link is invalid; and
highlighting each link that is determined to be invalid.

2. A method according to claim 1, and further comprising preventing the sending of the message if the message contains one or more invalid links.

3. A method according to claim 1, wherein the step of highlighting each link that is determined to be invalid occurs as the message is created.

4. A method according to claim 1, wherein the step of highlighting each link that is determined to be invalid occurs when a send message request is received.

5. A method according to claim 1, wherein a link is determined to be invalid if an error message is returned from the link.

6. A method according to claim 1, wherein a link is determined to be invalid if a redirection from an original link occurs.

7. A system for checking links in a message, the system comprising a processor arranged to:
detect the creation of a new message;
detect the presence of one or more links in the message;
determine if each link is invalid; and
highlight each link that is determined to be invalid.

8. A system according to claim 6, wherein the processor is further arranged to prevent the sending of the message if the message contains one or more invalid links.

9. A system according to claim 6, wherein the highlighting each link that is determined to be invalid occurs as the message is created.

10. A system according to claim 6, wherein the highlighting each link that is determined to be invalid occurs when a send message request is received.

11. A system according to claim 6, wherein a link is determined to be invalid if an error message is returned from the link.

12. A system according to claim 6, wherein a link is determined to be invalid if a redirection from an original link occurs.

13. A computer program product on a computer readable medium for checking links in a message, the product comprising instructions for:
detecting the creation of a new message;
detecting the presence of one or more links in the message;
determining if each link is invalid; and
highlighting each link that is determined to be invalid.

14. A computer program product according to claim 11, and further comprising instructions for preventing the sending of the message if the message contains one or more invalid links.

15. A computer program product according to claim 11, wherein the highlighting each link that is determined to be invalid occurs as the message is created.

16. A computer program product according to claim 15, wherein each link is forwarded to a server to determined validity.

17. A computer program product according to claim 11, wherein the highlighting each link that is determined to be invalid occurs when a send message request is received.

18. A computer program product according to claim 11, wherein a link is determined to be invalid if an error message is returned from the link.

19. A computer program product according to claim 11, wherein a link is determined to be invalid if a redirection from an original link occurs.

20. A computer program product according to claim 11, wherein a reason is provided if a link is determined to be invalid.
